(19) United States
(12) Patent Application Publication
(10) Pub. No.: US 2025/0250847 A1
(43) Pub. Date: Aug. 7, 2025

(54) INSULATING GLASS UNITS, SPACERS FOR INSULATING GLASS UNITS, AND METHODS FOR PRODUCING INSULATING GLASS UNITS

(71) Applicant: Pella Corporation, Pella, IA (US)

(72) Inventor: Paul Douglas Schroder, Pella, IA (US)

(21) Appl. No.: 19/045,211

(22) Filed: Feb. 4, 2025

Related U.S. Application Data
(60) Provisional application No. 63/550,696, filed on Feb. 7, 2024.

(51) Int. Cl. E06B 3/663; E06B 3/673

(52) U.S. Cl. CPC E06B 3/66366; E06B 3/66319; E06B 3/66361; E06B 3/67313; E06B 2003/66385

(57) ABSTRACT

Insulating glass units and spacers for securing the glass panes in insulating glass units are disclosed. The spacers may include a first chamber and second chamber formed therein. Particulate filters, gas filters (e.g., activated carbon for removing organics), desiccant bodies, getters (e.g., hydrogen sulfide getters) and combinations thereof may be disposed in the first and/or second chambers.

### CROSS-REFERENCE TO RELATED APPLICATIONS

This application claims the benefit of U.S. Provisional Patent Application No. 63/550,696, filed Feb. 7, 2024, which is incorporated herein by reference in its entirety.

### TECHNICAL FIELD

The field of the disclosure relates to insulating glass units and spacers for securing glass panes in insulating glass units. The field of the disclosure also relates to methods for producing insulating glass units.

### BACKGROUND

Insulating glass units include panes of glass that are separated by a spacer that extends around the periphery of the glass panes. Some insulating glass units are sealed systems that incorporate a gas such as argon which is more insulating than air. Such systems are relatively expensive and argon slowly diffuses out of the system. Argon may diffuse out of the insulating glass unit faster than air diffuses in causing the glass to become concave. Other insulating glass units incorporate air between the window panes. Air contains moisture which can condense on the window surfaces within the glass unit. Air sometimes also includes an amount of hydrogen sulfide as pollution which may corrode a low-emissivity coating of the insulating glass unit. Air may also include condensable organic vapors that may cause the glass to fog.

A need exists for insulating glass units that incorporate air, that reduce condensation and that remove hydrogen sulfide and organics, are relatively cost efficient to manufacture, and are characterized by lower thermal conductivity relative to other spacers.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed to a spacer for spacing apart a plurality of window panes. The spacer includes a polymer spacer body having a first edge rabbet, a second edge rabbet, and a groove disposed between the first edge rabbet and the second edge rabbet. The groove is parallel to the first edge rabbet and the second edge rabbet. The spacer includes a polymer spacer back plate that is fixed to the spacer body. The spacer body and spacer back plate define a first chamber disposed between the first edge rabbet and the groove and a second chamber disposed between the second edge rabbet and the groove.

Another aspect of the present disclosure is directed to a multi-pane insulating glass unit. The multi-pane insulating glass unit includes a spacer having a spacer body and a spacer back plate that is fixed to the spacer body. The spacer body includes a first edge rabbet, a second edge rabbet, and a groove disposed between the first edge rabbet and the second edge rabbet. The groove is parallel to the first edge rabbet and the second edge rabbet. The spacer back plate is fixed to the spacer body. The spacer body and spacer back plate define a first chamber disposed between the first edge rabbet and the groove and a second chamber disposed between the second edge rabbet and the groove. A first window pane is disposed in the first edge rabbet. A second window pane is disposed in the second edge rabbet. A third window pane is disposed in the groove.

A further aspect of the present disclosure is directed to a multi-pane insulating glass unit. The multi-pane insulating glass unit includes a spacer having an outer surface. The spacer includes a spacer body and a spacer back plate that is fixed to the spacer body. The spacer body includes a first edge rabbet and a second edge rabbet. A first window pane is disposed in the first edge rabbet. A second window pane is disposed in the second edge rabbet. A moisture vapor barrier film contacts the first window pane, the outer surface of the spacer and the second window pane.

Yet another aspect of the present disclosure is directed to a multi-pane insulating glass unit. The multi-pane insulating glass unit includes a spacer having first and second recesses. The spacer has an outer surface. A first window pane is disposed in the first recess. A second window pane is disposed in the second recess. A moisture vapor barrier film contacts the first window pane, the outer surface of the spacer and the second window pane. The moisture vapor barrier film includes glass fibers embedded within the moisture vapor barrier film.

Yet a further aspect of the present disclosure is directed to a method for assembling a multi-pane insulating glass unit. A spacer for spacing at least three window panes is provided. The spacer includes a polymer spacer body and a polymer spacer back plate. The spacer body includes a first edge rabbet, a second edge rabbet, and a groove disposed between the first edge rabbet and the second edge rabbet. The spacer body and spacer back plate define a first chamber disposed between the first edge rabbet and the groove. A second chamber is disposed between the second edge rabbet and the groove. A plurality of corners are formed in the spacer by crushing the spacer at a plurality of corner sites. A first window pane is positioning in the first edge rabbet. A second window pane is positioned in the second edge rabbet. A third window pane is positioned in the groove. Each corner of the plurality of corners is in contact with a corner of the first window pane, a corner of the second window pane and a corner of the third window pane. A moisture vapor barrier film is adhered to the first window pane, the spacer back plate, and the second window pane such that the first window pane and second window pane are sealed to the spacer.

Another aspect of the present disclosure is directed to a multi-pane insulating glass unit. The multi-pane insulating glass unit includes a spacer having a first chamber and a second chamber disposed therein. A first window pane is in contact with the spacer. A second window pane is in contact with the spacer. A third window pane is disposed between the first window pane and the second window pane. The third window is in contact with the spacer. The first window pane and the third window pane form a first gas space. The second window pane and the third window pane form a second gas space. A first desiccant body is disposed in the first chamber. A second desiccant body is disposed in the second chamber.

Yet another aspect of the present disclosure is directed to a multi-pane insulating glass unit. The multi-pane insulating glass unit includes a spacer having a first chamber and a second chamber disposed therein. A first window pane is in contact with the spacer. A second window pane is in contact with the spacer. A third window pane is disposed between the first window pane and the second window pane. The third window is in contact with the spacer. The first window pane and the third window pane form a first gas space. The second window pane and the third window pane form a second gas space. A port is in fluid communication with the second chamber. The insulating glass unit forms a fluid pathway that passes from the first gas space to the first chamber, from the first chamber to the second gas space, from the second gas space to the second chamber, and from the second chamber to the port.

Yet a further aspect of the disclosure is directed to a multi-pane insulating glass unit. The multi-pane insulating glass unit includes a spacer having a first chamber and a second chamber disposed therein. A first window pane is in contact with the spacer. A second window pane is in contact with the spacer. A third window pane is disposed between the first window pane and the second window pane. The third window is in contact with the spacer. The first window pane and the third window pane form a first gas space. The second window pane and the third window pane form a second gas space. A desiccant body is disposed in the first chamber and/or the second chamber. A gas filter is disposed in the first chamber and/or the second chamber.

Another aspect of the disclosure is directed to a multi-pane insulating glass unit. The multi-pane insulating glass unit includes a spacer having first and second recesses. The spacer includes glass fibers embedded therein. A first window pane is disposed in the first recess. A second window pane is disposed in the second recess.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective view of a three-pane insulating glass unit;

FIG. 2 is a detailed perspective cross-section view of the insulating glass unit;

FIG. 3 is a detailed perspective cross-section view of the insulating glass unit with the glass panes not shown;

FIG. 4 is a detailed perspective cross-section view of the spacer of the insulating glass unit;

FIG. 5 is a detailed perspective cross-section view of the spacer body;

FIG. 6 is a perspective view of the spacer and a corner connector that connects the space ends;

FIG. 7 is a side view of the corner connector;

FIG. 8 is a top view of the corner connector;

FIG. 9 is a perspective view of the insulating glass unit showing the first and second chambers within the spacer;

FIG. 10 is a detailed perspective view of the corner connector;

FIG. 11 is a detailed perspective view of the insulating glass unit showing components within the first and second chambers of the spacer;

FIG. 12 is another detailed perspective view of the insulating glass unit showing components within the first and second chambers of the spacer;

FIG. 13 is a perspective view of the spacer and corner connector;

FIG. 14 is a perspective view of another embodiment of a three-pane insulating glass unit;

FIG. 15 is a perspective view of the insulating glass unit of FIG. 14 showing components within the first and second chambers of the spacer;

FIG. 16 is a side view of the insulating glass unit of FIG. 14 showing the first and second ends of the spacer;

FIG. 17 is a perspective view of a further embodiment of a three-pane insulating glass unit;

FIG. 18 is a perspective view of the insulating glass unit of FIG. 17 showing the components within the first and second chambers of the spacer;

FIG. 19 is a perspective view of the insulating glass unit of FIG. 17 showing the first and second ends of the spacer;

FIG. 20 is a perspective view of a an embodiment of a three-pane insulating glass unit having a breather;

FIG. 21 is a perspective view of the insulating glass unit of FIG. 20 showing the inlet of the breather;

FIG. 22 is a perspective view of the insulating glass unit of FIG. 20 showing a filter body that is disposed within the breather;

FIG. 23 is a perspective view of the insulating glass unit of FIG. 20 showing two ports through which gas cycles in and out of the insulating glass unit;

FIG. 24 is a perspective view of the insulating glass unit of FIG. 20 showing the components within the first and second chambers of the spacer;

FIG. 25 is another perspective view of the insulating glass unit of FIG. 20 showing the components within the first and second chambers of the spacer;

FIG. 26 is a perspective view of the insulating glass unit of FIG. 20 showing the first and second ends of the spacer;

FIG. 27 is a perspective view of a an embodiment of a three-pane insulating glass unit having an alternative breather;

FIG. 28 is a perspective view of the insulating glass unit of FIG. 27 showing a filter body that is disposed within the breather;

FIG. 29 is a perspective view of the insulating glass unit of FIG. 27 showing two ports through which gas cycles in and out of the insulating glass unit;

FIG. 30 is a front view of a spacer of an insulating glass unit after crushing to form a preformed corner; and

FIG. 31 is a front view of the spacer showing the preformed corner.

Corresponding reference characters indicate corresponding parts throughout the drawings.

### DETAILED DESCRIPTION

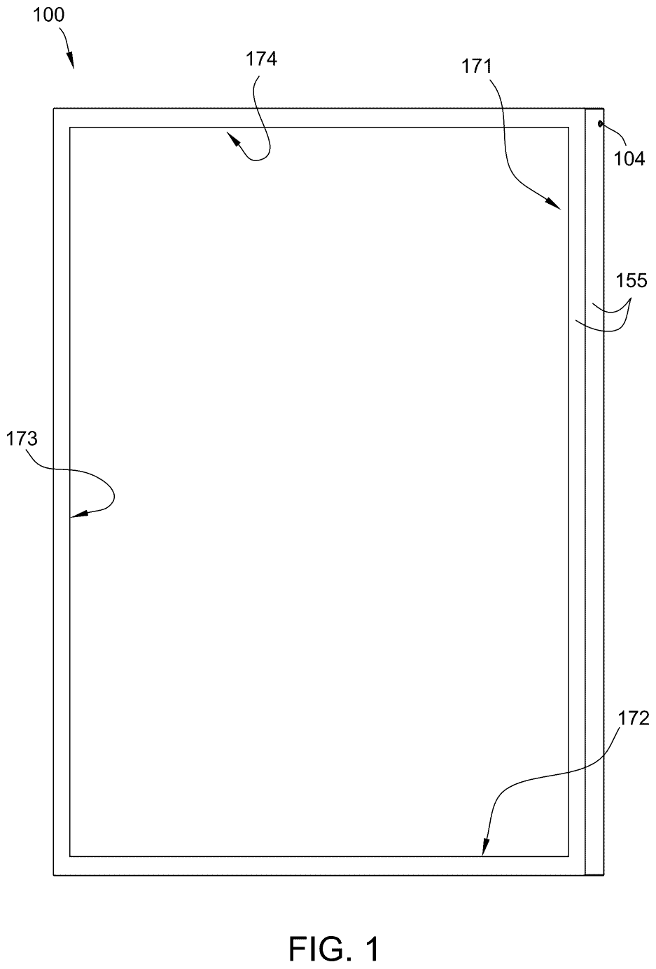

Provisions of the present disclosure relate to multi-pane insulating glass units (e.g., triple-pane), spacers for spacing apart two, three, four or more window panes in an insulating glass unit, and methods for assembling a multi-pane insulating glass unit. Referring now to FIG. 1, a multi-pane insulating glass unit 100 (or more simply “insulating glass unit”) is shown. The insulating glass unit 100 includes a port or channel 104 through which gas (i.e., air) cycles in and out of the insulating glass unit 100. While the insulating glass units shown and described herein may be triple-pane insulating glass units, unless stated otherwise, the present disclosure should not be limited to three-pane insulating glass units and this disclosure encompasses two-pane insulating glass units and insulating glass units having four, five or more panes.

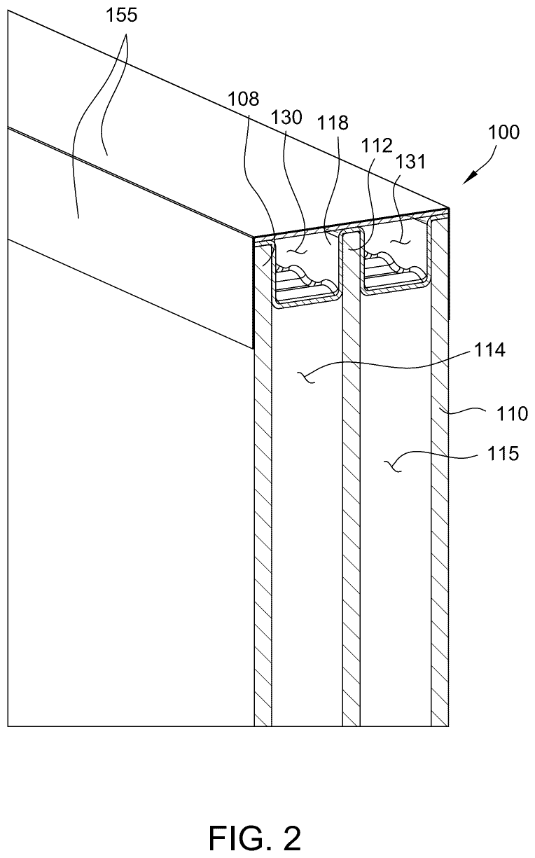

Referring now to FIG. 2, the insulating glass unit 100 includes a first window pane 108, a second window pane 110 and a third window pane 112 disposed between the first window pane 108 and second window pane 110. The first window pane 108 and the third window pane 112 form a first gas space 114 disposed between the panes 108, 112. The second window pane 110 and the third window pane 112 form a second gas space 115 disposed between the panes 110, 112.

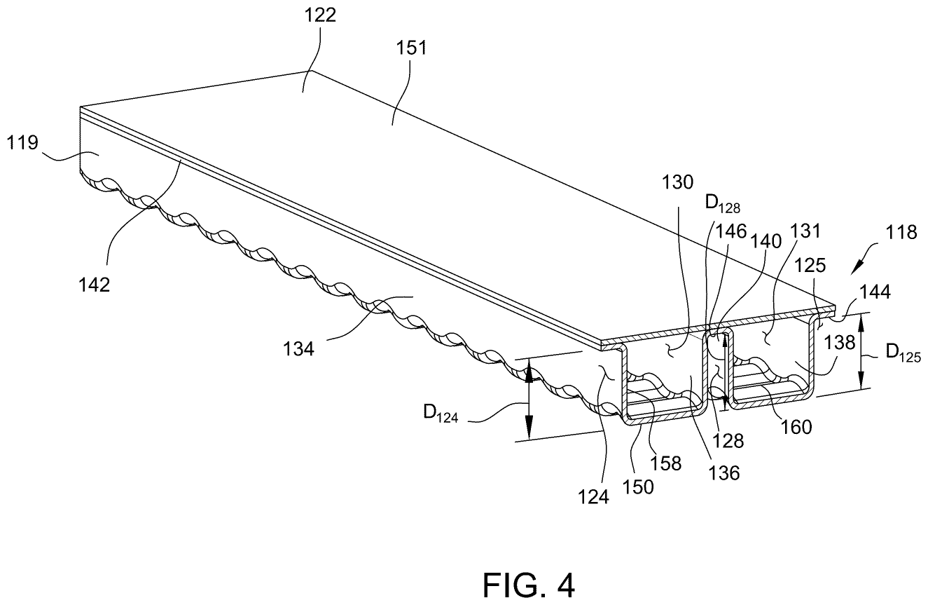

The first, second and third window panes 108, 110, 112 are separated from each other by a spacer 118. Referring now to FIG. 4, the spacer 118 includes a spacer body 119 and spacer back plate 122. The spacer back plate 122 may be fixed to the spacer body 119. For example, the spacer back plate 122 may be integral with the spacer body 119 (e.g., formed of one piece). In other embodiments, the spacer back plate 122 is fixed to the spacer body 119 by welding (i.e., by a welding seam) or by an adhesive. The spacer body 119 and back plate 122 may be relatively thin (i.e., the strip material used to form the body 119 into its shape is relative thin). In some embodiments, the strip material(s) used to form the spacer body 119 and the back plate 122 has a thickness of about 1 mm or less, 750 μm or less, 500 μm or less, 250 μm or less or 150 μm or less (e.g., 100 μm to 1 mm or 100 μm to 500 μm). In some embodiments, the spacer body 119 and back plate 122 are both made of a polymer. Example polymers include HDPE, LDPE, and polypropylene. In other embodiments, the spacer 118 is made of metal. In some embodiments, the spacer body 119 and/or the back plate 122 includes glass fibers that are embedded within the body 119 and/or back plate 122.

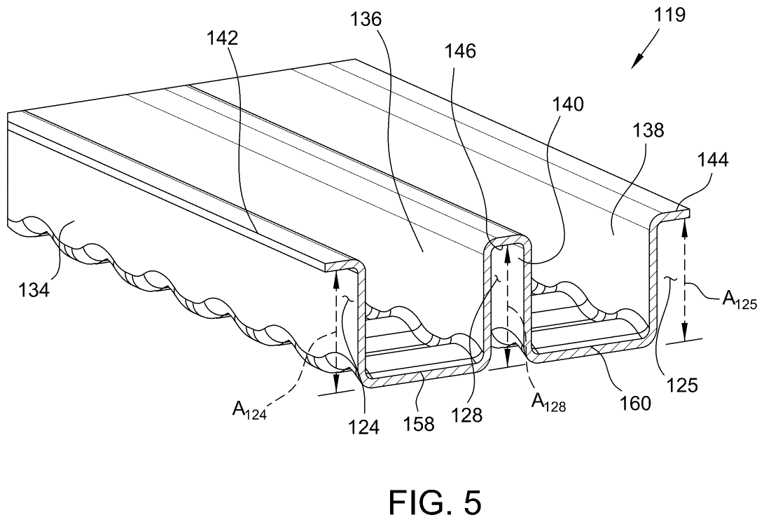

The spacer body 119 (FIG. 5) includes a first edge rabbet 124 and a second edge rabbet 125. A groove 128 is disposed between the first edge rabbet 124 and the second edge rabbet 125. The groove 128 is parallel to the first edge rabbet 124 and the second edge rabbet 125 (i.e., the rabbets 124, 125 and groove 128 having respective vertical axes A₁₂₄, A₁₂₅, and A₁₂₈ when viewed in cross-section that are parallel to each other). The first window pane 108 (FIG. 2) is disposed in the first edge rabbet 124, the second window pane 110 is disposed in the second edge rabbet 125 and the third window pane 112 is disposed in the groove 128.

Referring now to FIG. 4, the spacer back plate 122 and the spacer body 119 define a first chamber 130 and a second chamber 131. The first chamber 130 is disposed between the first edge rabbet 124 and the groove 128. The second chamber 131 is disposed between the second edge rabbet 125 and the groove 128.

The first edge rabbet 124 is defined by a first chamber outer wall 134 and first edge rabbet floor 142. The second edge rabbet 125 is defined by the second chamber outer wall 138 and second edge rabbet floor 144. The groove 128 is defined by the first chamber inner wall 136, second chamber inner wall 140 and groove floor 146. The spacer 118 has an inner surface 150 (i.e., the surface closest to a center of the insulating glass unit 100) and an outer surface 151 (i.e., the surface most distant from a center of the insulating glass unit 100). The first edge rabbet 124 and has a depth D₁₂₄ that extends from the inner surface 150 to the first edge rabbet floor 142. The second edge rabbet 125 has a depth D₁₂₅ that extends from the inner surface 150 to the second edge rabbet floor 144. The groove 128 has a groove depth D₁₂₈ that extends from the inner surface 150 to the groove floor 146. In the illustrated embodiment, the first edge rabbet depth D₁₂₄, second edge rabbet depth D₁₂₅, and groove depth D₁₂₈ are equal depths.

In some embodiments, the inner surface 150 of the spacer 118 includes corrugations that are perpendicular to the groove 128. For example, the spacer 118 may include first chamber corrugations 158 (FIG. 4) and second chamber corrugations 160.

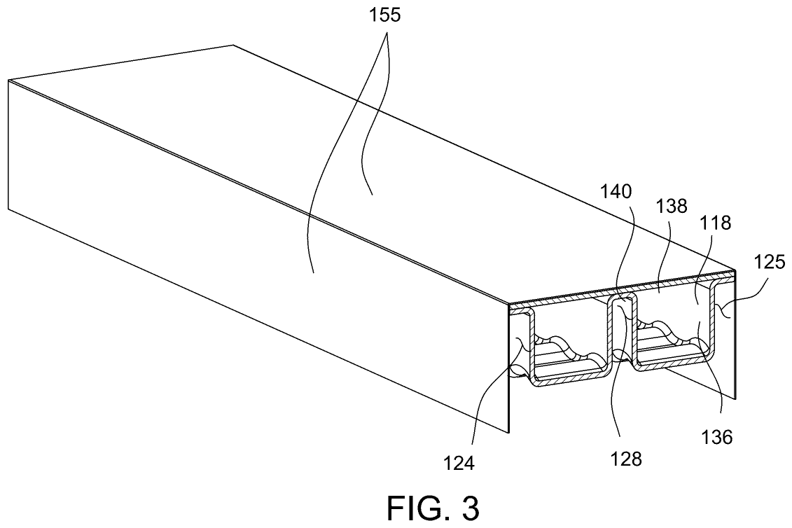

Referring now to FIG. 3, the insulating glass unit 100 incudes a moisture vapor barrier film 155 to seal the first and second gas spaces 114, 115 (FIG. 2. The moisture vapor barrier film 155 contacts the first window pane 108, the outer surface 151 of the spacer 118 and the second window pane 110 (i.e., contacts the outer surfaces of the first and second window panes 108, 110). The moisture vapor barrier film 155 may be made of a polymer such as polyethylene (HDPE). The moisture vapor barrier film 155 may be a lamination of one or more materials such as a lamination of polyester and layers of ethylene vinyl alcohol (EVOH) (e.g., three layers of EVOH). EVOH layers may have a metalized (aluminized) coating disposed on them. In some embodiments, the moisture vapor barrier film 155 includes glass fibers that are embedded within the film 155. Such films 155 with glass fibers embedded therein may be used in insulating glass units other than the illustrated insulating glass units (e.g., any glass unit having one or two gas spaces formed therein such as two- or three-pane glass units in which the panes are secured within recesses of a spacer). The moisture vapor barrier film 155 may be bonded to the glass and spacer surfaces by applying a moisture vapor barrier tape to the surfaces and applying pressure to cause the tape to adhesively bond to the surfaces (and optionally heat such as at corners).

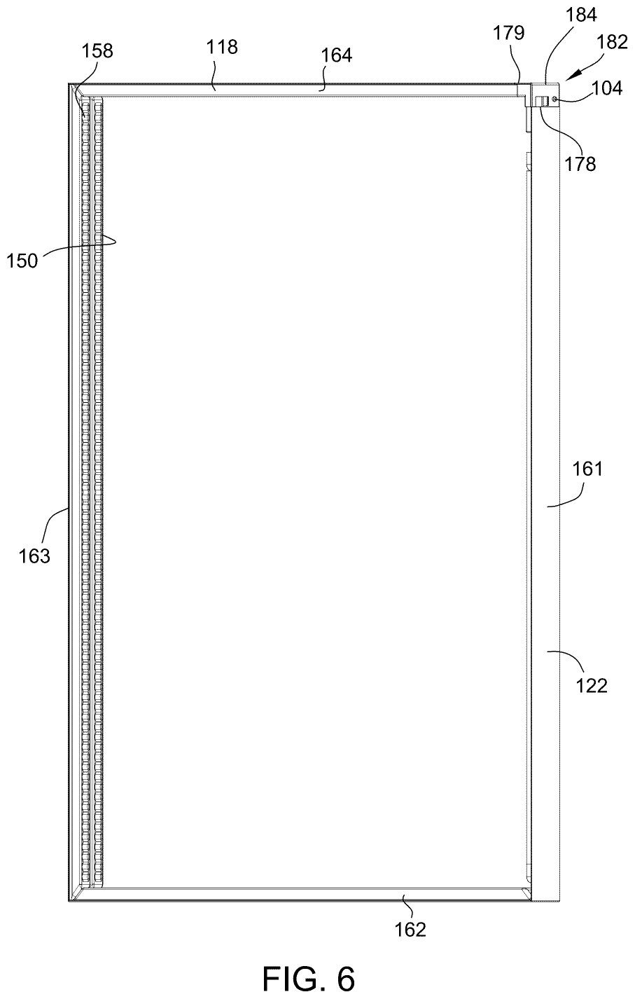

Referring now to FIG. 6, after the insulating glass unit is manufactured, the spacer 118 includes four section—a first section 161 that secures the first sides 171 (FIG. 1) of the three window panes 108, 110, 112, a second section 162 that secures the second sides 172 of the three window panes, a third section 163 that secures the third sides 173 of the three window panes, and a fourth section 164 that secures the fourth sides 174 of the three window panes. The first and second chambers 130, 131 extend within the first, second, third and fourth sections 161, 162, 163, 164 of the spacer 118 (and are interrupted at the corners, i.e., the chambers 130, 131 are not continuous). The spacer sections 161, 162, 163, 164 may be sealed from each other or, as in other embodiments, an amount of gas may pass between sections (e.g., corners may not be hermetically sealed).

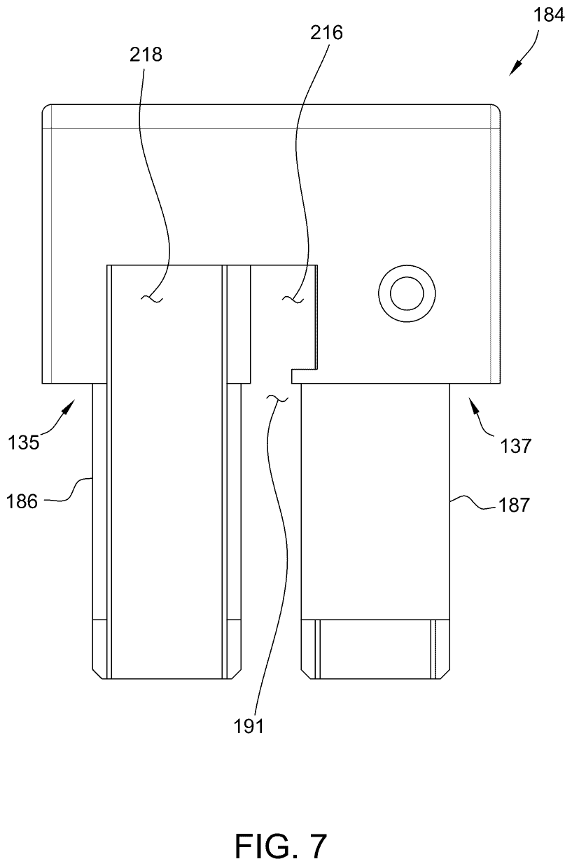

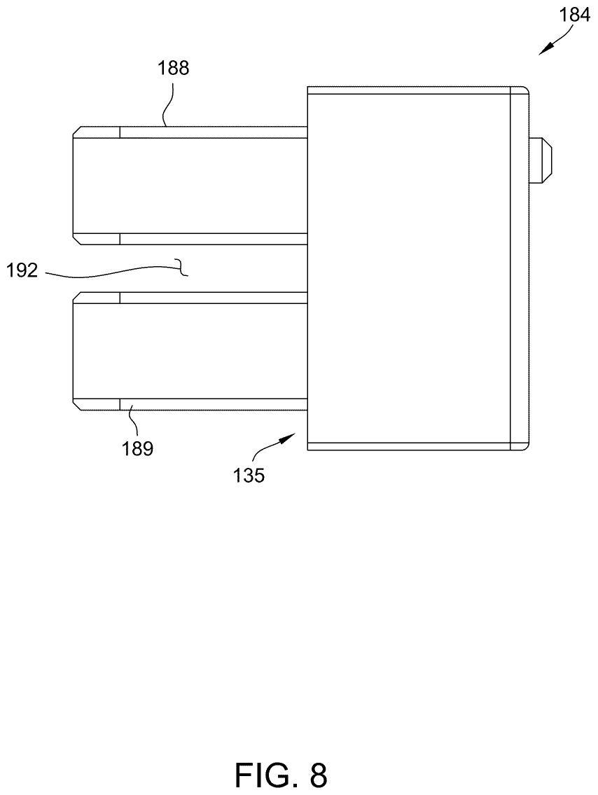

The spacer 118 has a first end 178 and a second end 179. Once assembled on the window panes 108, 110, 112, the ends 178, 179 of the spacer 118 may be separated by a gap 182. In the illustrated embodiment, a corner connector 184 bridges the gap 182 between spacer ends 178, 179. The corner connector 184 is connected to the spacer 118 toward each end 178, 179 of the spacer 118. The corner connector 184 includes a first set of legs 186, 187 (FIG. 7) that are received within the first and second spacer chambers 130, 131 (FIG. 2) at the first end 178 (FIG. 6) of the spacer 118 and a second set of legs 188, 189 (FIG. 8) that are received within the first and second spacer chambers 130, 131 at the second end 179 (FIG. 6) of the spacer 118. The third window pane 112 (FIG. 2) may be received in a first inner recess 191 (FIG. 7) disposed between the first set of legs 186, 187 and a second inner recess 192 (FIG. 8) disposed between the second set of legs 188, 189. The first window pane 108 (FIG. 2) may be disposed within a first outer recess 135 of the connector 184 and the second window pane 110 (FIG. 2) may be disposed within a second outer recess 137.

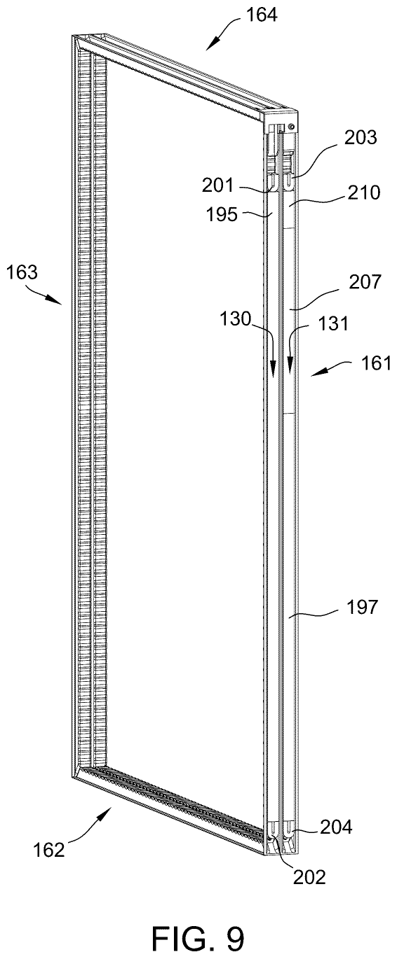

Referring now to FIG. 9, the chambers 130, 131 may include various functional bodies within a portion of the chambers 130, 131. In the illustrated embodiment, the functional bodies are disposed within the first section 161 of the spacer 118. In other embodiments, the bodies may be disposed within the second section 162, third section 163, fourth section 164, or a combination of the first section 161, second section 162, third section 163, and/or fourth section 164. In the illustrated embodiment, the first chamber 130 of the spacer 118 includes a first desiccant body 195 disposed within at least a portion of the first chamber 130. The second chamber 131 includes a second desiccant body 197 disposed within at least a portion of the second chamber 131. Example desiccant bodies 195, 197 may be made of silica. Other materials may be used (e.g., which absorb and desorb in the relative humidity range of the gas space such as 10-90% relative humidity and/or which reduce hysteresis in absorption and desorption). In some embodiments, the desiccant is not a molecular sieve and is not a zeolite.

The first and second chambers 130, 131 may also have one or more filter bodies (or more simply “one or more filters”) disposed therein. In the embodiment illustrated in FIG. 9, the first chamber 130 includes first and second filters 201, 202 disposed therein. The second chamber 131 includes third and fourth filters 203, 204 disposed therein. The first filter, second filter, third filter, and fourth filter 201, 202, 203, 204 (which may also be referred to herein as “filter plugs”) may be particulate filters (e.g., HEPA filters) which remove particulate from gas circulated in and out of the insulating glass unit 100. The filters 201, 202, 203, 204 may be made of felt. Each filter 201, 202, 203, 204 may be at a respective end of the stack of materials in each respective chamber.

In some embodiments, the first and/or second chambers 130, 131 includes one or more additional filter bodies (i.e., non-felt filters). In the illustrated embodiment, a filter body 207 for filtering gas (“gas filter body”) is disposed at least partially in the second chamber 131. The filter body 207 may filter out organic compounds from the gas. In some embodiments, the gas filter body 207 is made of activated carbon.

In some embodiments, the first and/or second chambers 130, 131 includes one or more getter bodies 210 (e.g., for removing hydrogen sulfide) disposed within at least one of the first and second chambers 130, 131. In the illustrated embodiment, the second chamber 131 includes a getter body 210 disposed within the second chamber 131. The getter body 210 may be adapted to remove hydrogen sulfide from the gas moving through the getter. In some embodiments, the getter body 210 comprises iron hydroxide.

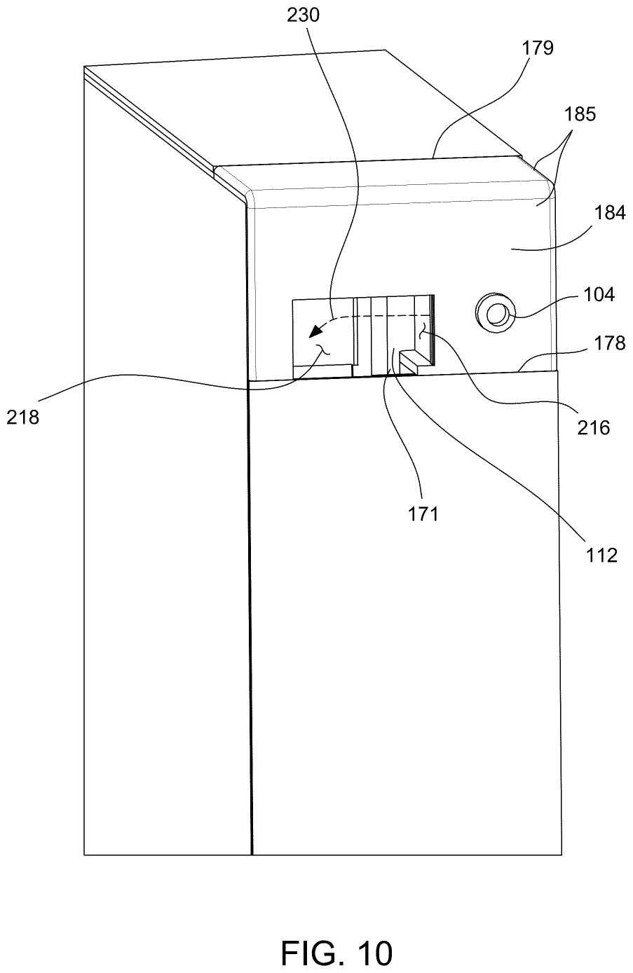

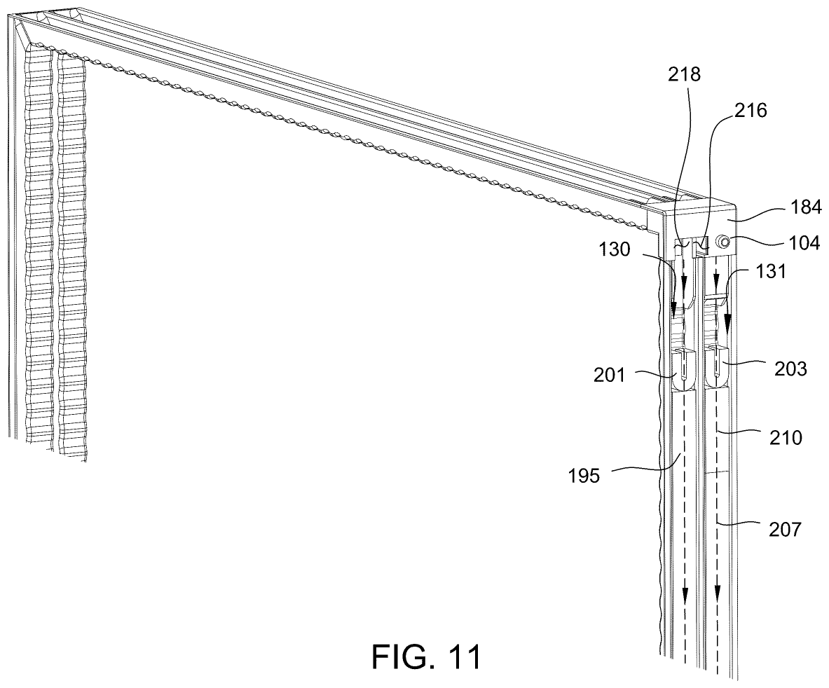

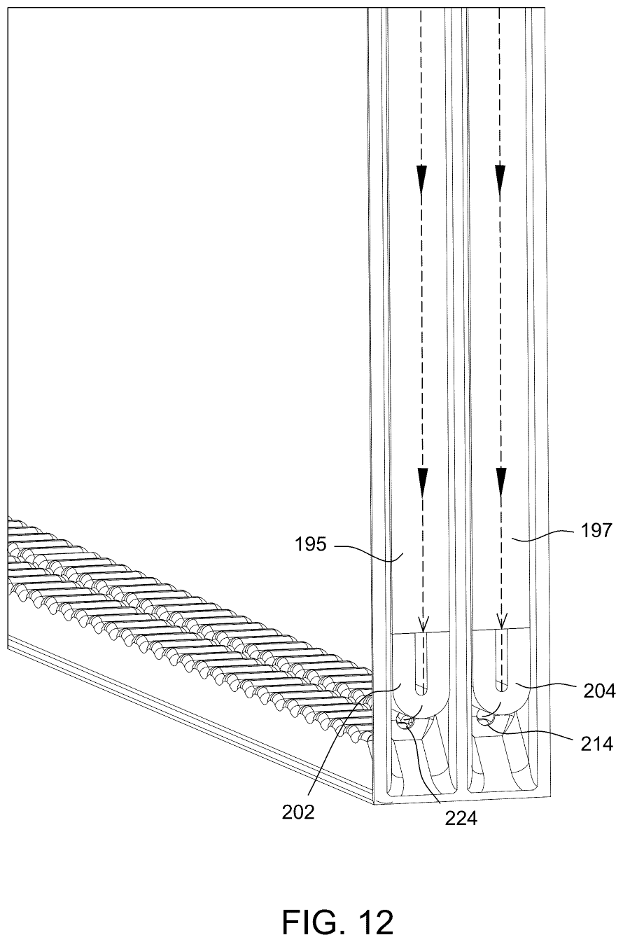

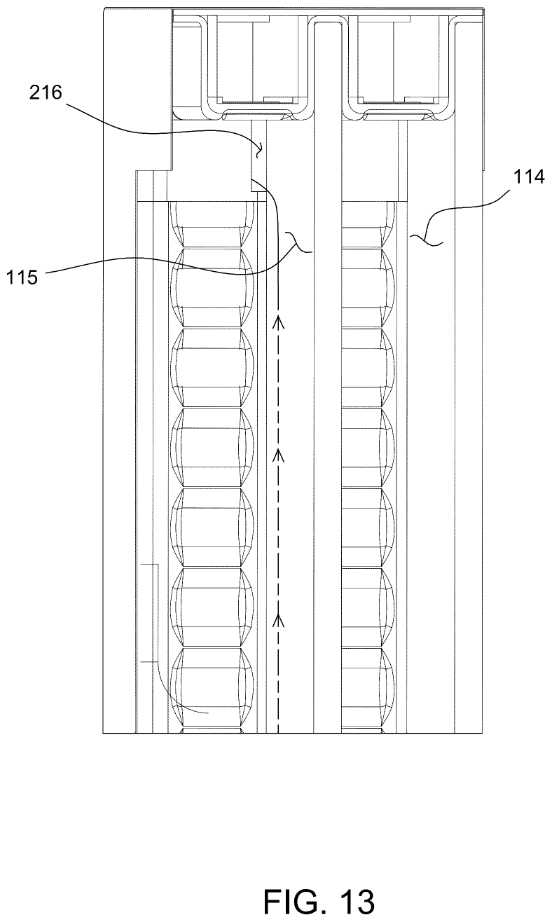

During thermal cycles and atmospheric pressure changes of the insulating glass unit 100, gas within the first and second inner gas spaces 114, 115 (FIG. 2) contracts or expands (e.g., with changes in temperature during the day and night). During evenings in which the gas contracts as it cools, air is drawn through the port 104 and moves toward the inner gas spaces 114, 115. The port 104 extends through the moisture vapor barrier film 155 (FIG. 1) and through the corner connector outer housing 185 (FIG. 10). As shown in FIG. 11, the air passes through the corner connector 184 and through the third filter 203 disposed in the second chamber 131. The gas continues through the getter body 210 and then passes through the activated carbon filter body 207. The gas then continues through the second desiccant body 197 (FIG. 9). As shown in FIG. 12, the gas continues through the fourth filter 204 and passes through a first spacer opening 214 and into the second gas space 115 (FIG. 2) (which may be the interior gas space). As the gas in the first gas space 114 (which may be the exterior space) cools, it draws gas from the second gas space 115 through a first corner connector opening 216 (FIGS. 10 and 13). Referring now to FIG. 10, the gas passes through the corner connector opening 216, behind the third edge 171 of the third window pane 112, and into a second corner connector opening 218 and into the first chamber 130 (FIG. 11) formed by the spacer 118 (i.e., along a fluid channel 230 (FIG. 10) that interconnects the second gas space 115 and the first chamber 130 of the spacer 118).

Once in the chamber 130, gas passes through the first filter plug 201 (FIG. 9) and through the first desiccant body 195. The gas then passes through the second filter plug 202 and through the second spacer opening 224 (FIG. 12). The gas then enters the first gas space 114 (FIG. 2).

As the gas in the first and second gas spaces 114, 115 heats (e.g., during the daytime), the gas expands and flows in the opposite direction (i.e., from the respective gas spaces, through chambers 130, 131 and filter, getter, and desiccant bodies) through the port 104 and into the ambient. When air enters through the port 104 (upon cooling of the gas), moisture from the air is adsorbed onto the desiccant bodies 195, 197 and the moisture-depleted gas enters the gas spaces 114, 115. Upon heating, the moisture-depleted gas passes through the desiccant bodies 195, 197 and the desiccant bodies desorb moisture as the gas passes through the bodies 195, 197.

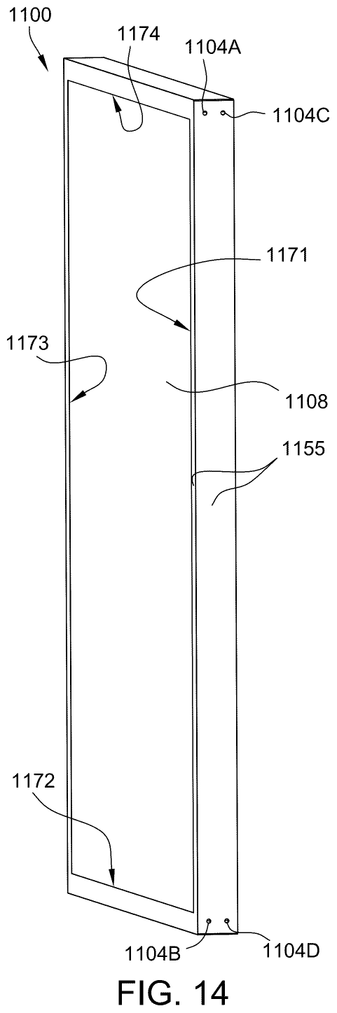

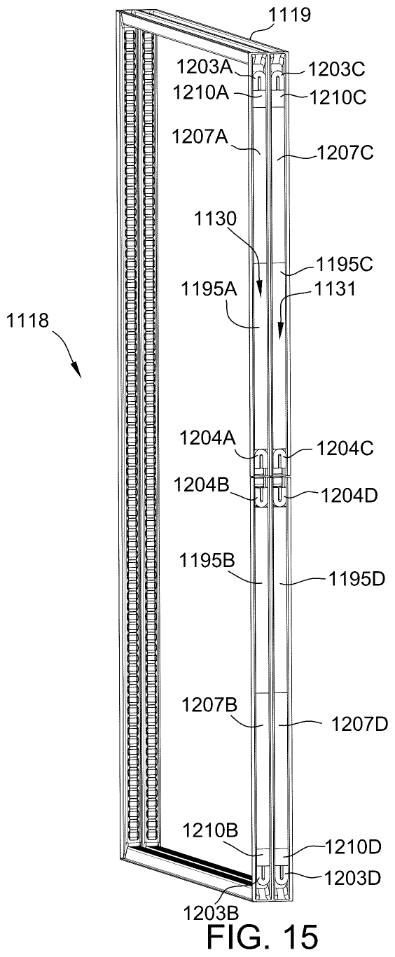

Another embodiment of the multi-pane insulating glass unit 1100 is shown in FIGS. 14-16. The components shown in FIGS. 14-16 that are analogous to those of FIGS. 1-13 are designated by the corresponding reference number of FIGS. 1-13 plus “1000” (e.g., part 123 becomes 1123). The insulating glass unit 1100 may be similar or identical to the glass unit 100 described above with the difference being the manner in which gas flows into and out of the inner gas spaces 1114, 1115 and the position at which the spacer ends 1178, 1179 meet. Rather than flowing into the chambers and various gas spaces in series as in the embodiment of FIGS. 1-13, the embodiment of the insulating glass unit 1100 illustrated FIGS. 14-16 includes four parallel gas pathways (two for each gas space 1114, 1115). The insulating glass unit 1100 includes four ports 1104A, 1104B, 1104C, 1104D. A fluid pathway that fluidly connects the atmosphere external to the insulating glass unit to the first or second chamber 1130, 1131 (FIG. 15) extends through each port 1104A, 1104B, 1104C, 1104D.

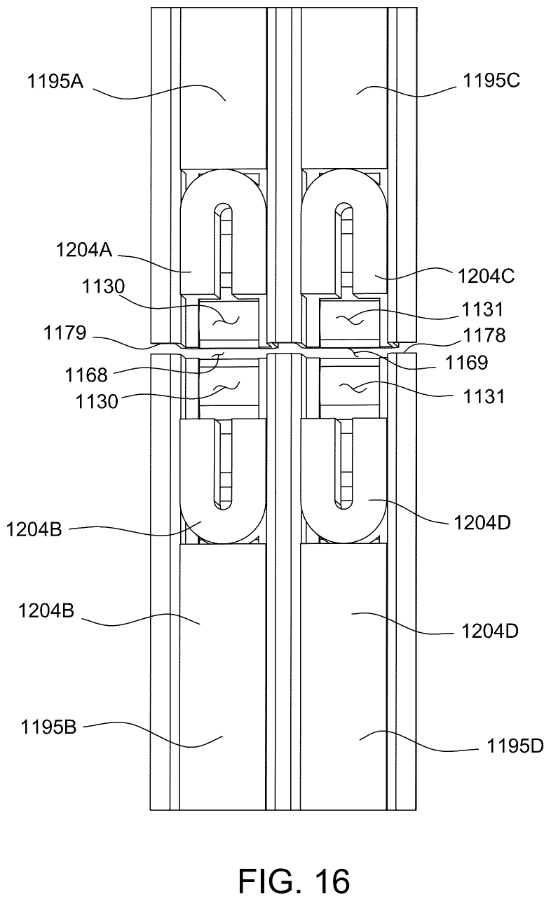

Referring now to the first gas pathway, gas flows through the port 1104A and through a first filter body 1203 (FIG. 15) (e.g., felt filter plug). The gas then passes through a getter body 1210A (e.g., iron hydroxide) and through a second filter body 1207A (e.g., activated carbon filter body). The gas then passes through a desiccant body 1195A and a third filter body 1204A. The gas then passes through a first gap 1168 (FIG. 16) formed between the two ends 1178, 1179 of the spacer 1118 into the first gas space 1114.

In the illustrated embodiment, the second, third and fourth gas flow paths are identical to the first gas flow path described above. Gas flows through the second port 1104B, through a set of filter, getter and desiccant bodies 1203B, 1210B, 1207B, 1195B, 1204B and through the first gap 1168 and into the first gas space 1114. Gas flows through the third port 1104C, through a similar set of filter, getter and desiccant bodies 1203C, 1210C, 1207C, 1195C, 1204C and through the second gap 1169 and into the second gas space 1115. Gas flows through the fourth port 1104D, through a similar set of filter, getter and desiccant bodies 1203D, 1210D, 1207D, 1195D, 1204D and through the second gap 1169 and into the second gas space 1115. Upon heating, the gasses flow in the opposite direction from the gas spaces 1114, 1115 and through the respective ports 1104A, 1104B, 1104C, 1104D.

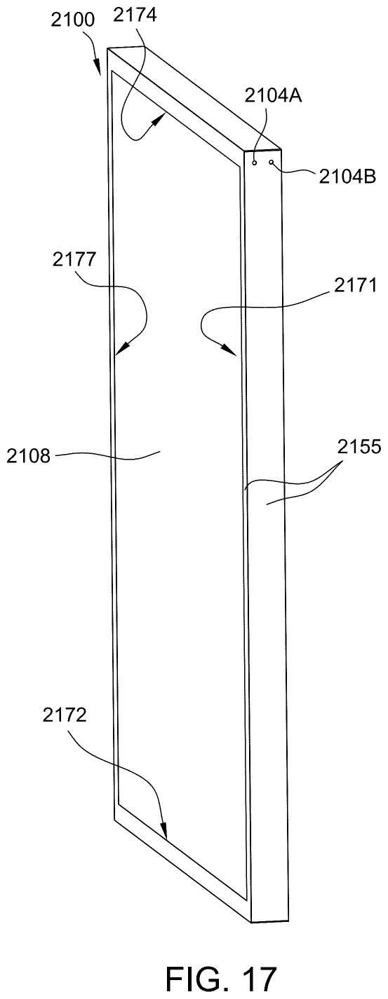

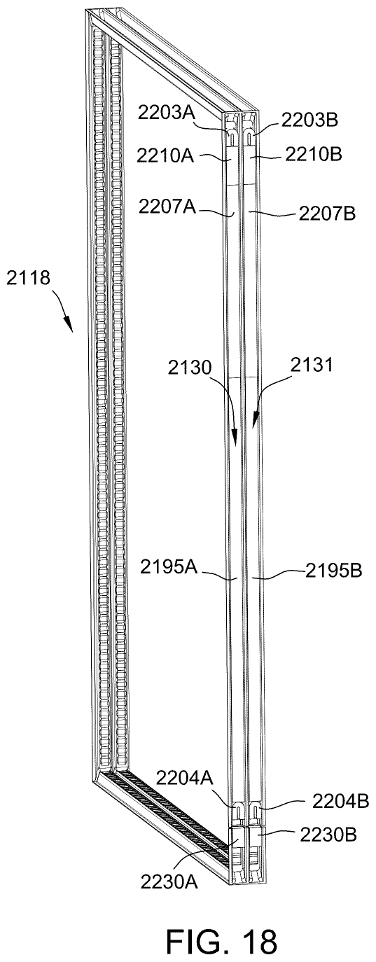

Another embodiment of the multi-pane insulating glass unit 2100 is shown in FIGS. 17-19. The components shown in FIGS. 17-19 that are analogous to those of FIGS. 1-13 are designated by the corresponding reference number of FIGS. 1-13 plus “2000” (e.g., part 123 becomes 2123). The insulating glass unit 2100 may be similar or identical to the glass unit 100 described above (with the same components) with the difference being the manner in which gas flows into and out of the inner gas spaces 2114, 2115 and the position at which the spacer ends 2178, 2179 meet. As shown in FIG. 18, instead of having four parallel gas pathways, the insulating glass unit 2100 includes two parallel gas pathways (one for each gas space 2114, 2115). The insulating glass unit 2100 includes two ports 2104A, 2104B (FIG. 17). A fluid pathway that fluidly connects the atmosphere external to the insulating glass unit to the first and second chambers 2130, 2131 (FIG. 18) extends through each port 2104A, 2104B.

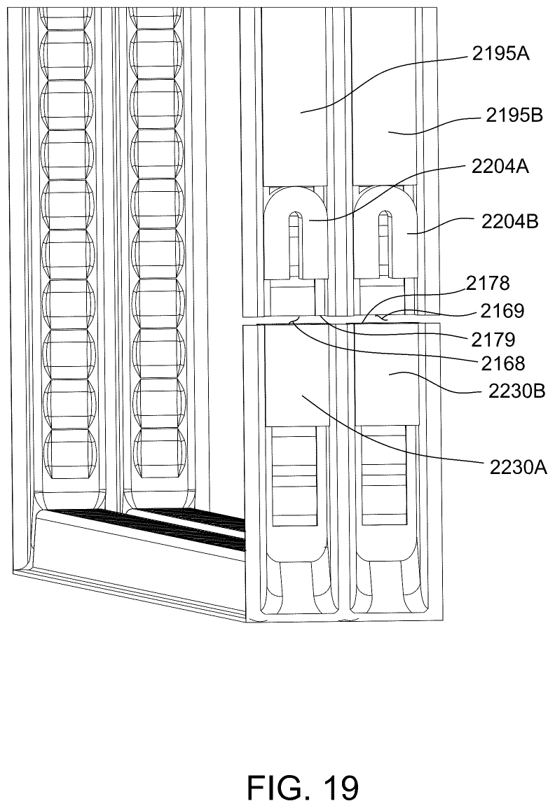

Referring now to the first gas pathway, gas flows through the port 2104A and through a first filter body 2203A (FIG. 18) (e.g., felt filter plug). The gas then passes through a getter body 2210A (e.g., iron hydroxide) and through a second filter body 2207A (e.g., activated carbon filter body). The gas then passes through a desiccant body 2195A and through a third filter body 2204A. The gas then passes through a first gap 2168 (FIG. 19) formed between the two ends 2178, 2179 of the spacer 2118 into the first gas space 2114.

In the illustrated embodiment, the second gas flow path is identical to the first gas flow path described above. Gas flows through the second port 2104B, through a set of filter, getter and desiccant bodies 2203B, 2210B, 2207B, 2195B, 2204B and through the second gap 2169 and into the second gas space 2115. Plugs 2230A, 2230B may be disposed at the spacer 2118 at the spacer end 2178 to prevent gases from moving into and out of the first and second gas spaces 2114, 2115.

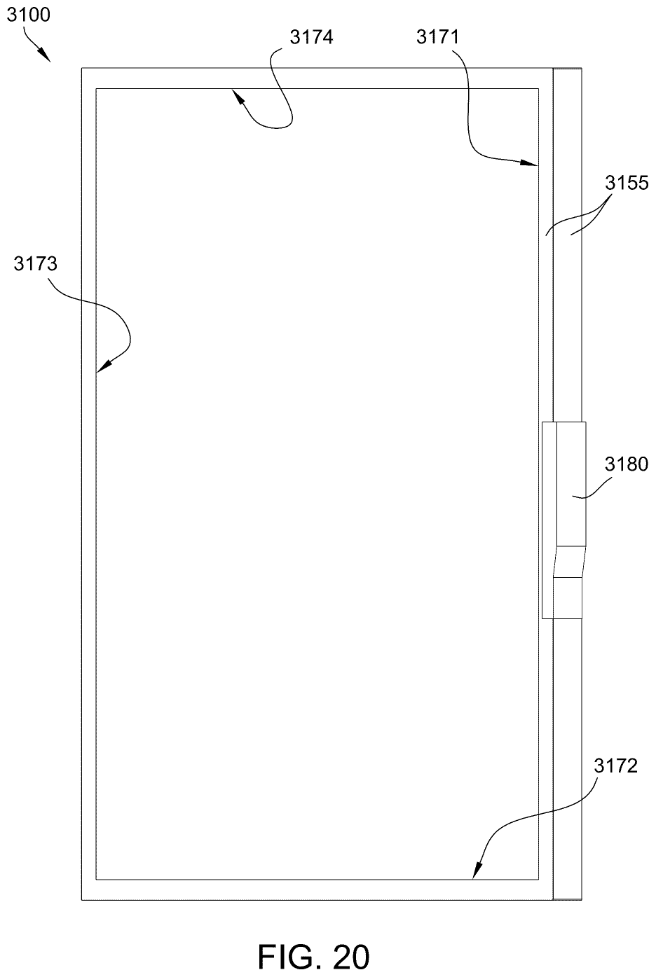

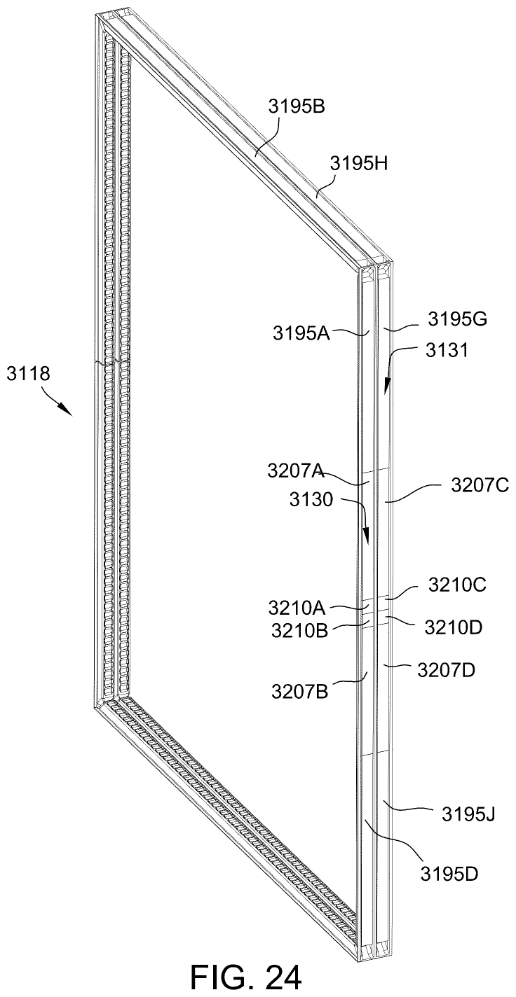

Another embodiment of the multi-pane insulating glass unit 3100 is shown in FIGS. 20-26. The components shown in FIGS. 20-26 that are analogous to those of FIGS. 1-13 are designated by the corresponding reference number of FIGS. 1-13 plus “3000” (e.g., part 123 becomes 3123). The insulating glass unit 3100 may be similar or identical to the glass unit 100 described above (with the same components) with the difference being described below. The insulating glass unit 3100 includes two parallel gas pathways (one for each gas space 3114, 3115). The insulating glass unit 3100 includes a breather 3180 in which gas passes through during thermal cycles and atmospheric pressure changes of the insulating glass unit 3100. While the breather 3180 is disposed on the first side 3171 of the window panes, in other embodiments the breather 3180 may be disposed on the second side 3172 or fourth side 3174.

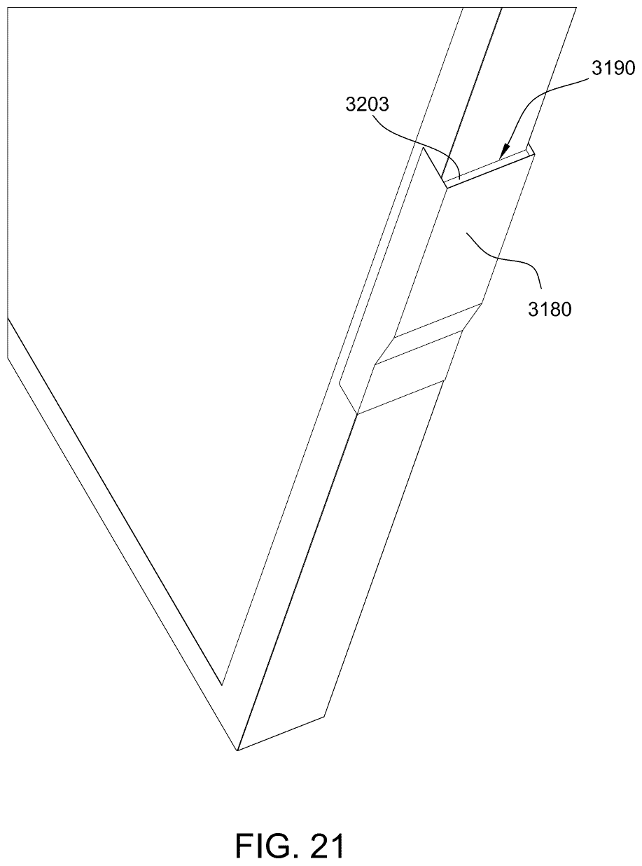

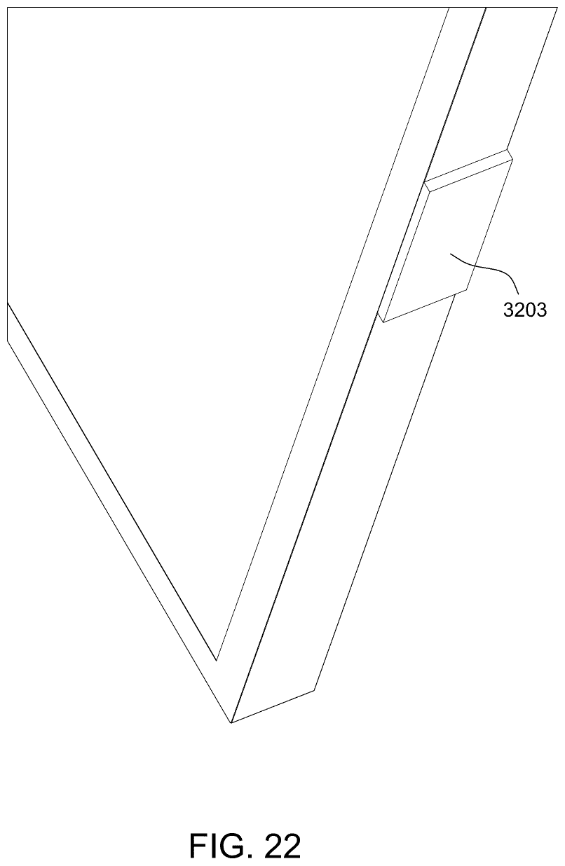

The breather 3180 includes a breather inlet 3190 (FIG. 21) through which gas passes during thermal cycles. The moisture vapor barrier film 3155 may extend over the sides and bottom of the breather 3180 and leave the breather inlet 3190 open. Disposed within the breather 3180 is a filter body 3203 (FIG. 22) (e.g., particulate filter body made of felt).

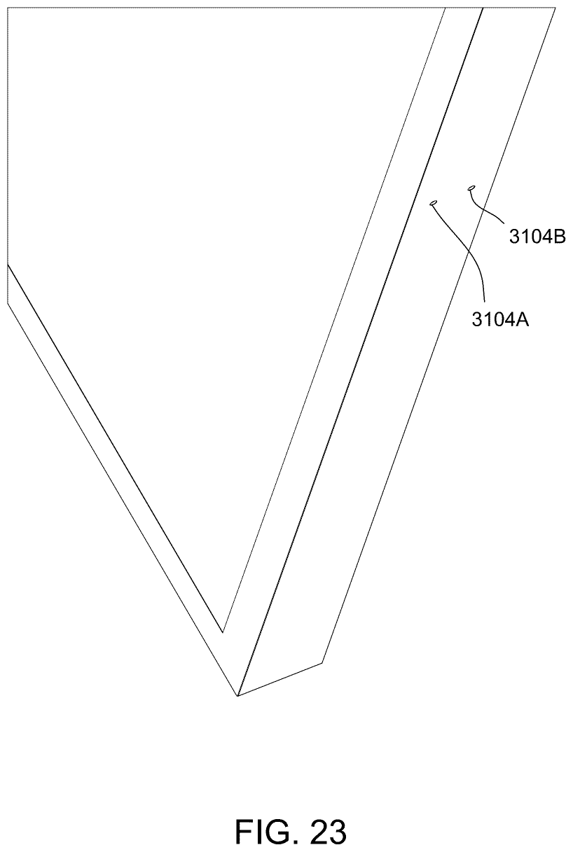

After gas passes through the filter body 3203, it passes through ports 3104A, 3104B (FIG. 23). A fluid pathway that fluidly connects the atmosphere external to the insulating glass unit 311 to the first and second chambers 3130, 3131 extends through the breather 3180, filter body 3203 and each port 3104A, 3104B.

Referring now to the first gas pathway, gas flows through the first port 3104A and through either a first getter body 3210A or a second getter body 3210B (e.g., iron hydroxide getter bodies). The gas may proceed in either direction to reach the inner gas space. While the getters are shown as discreet bodies, in other embodiments (including any other embodiment of the insulating glass unit described herein), the getter material may be blended with desiccant. After passing through the respective getter body 3210A, 3210B, the gas then passes through a second filter body 3207A or a third filter body 3207B (e.g., activated carbon filter bodies).

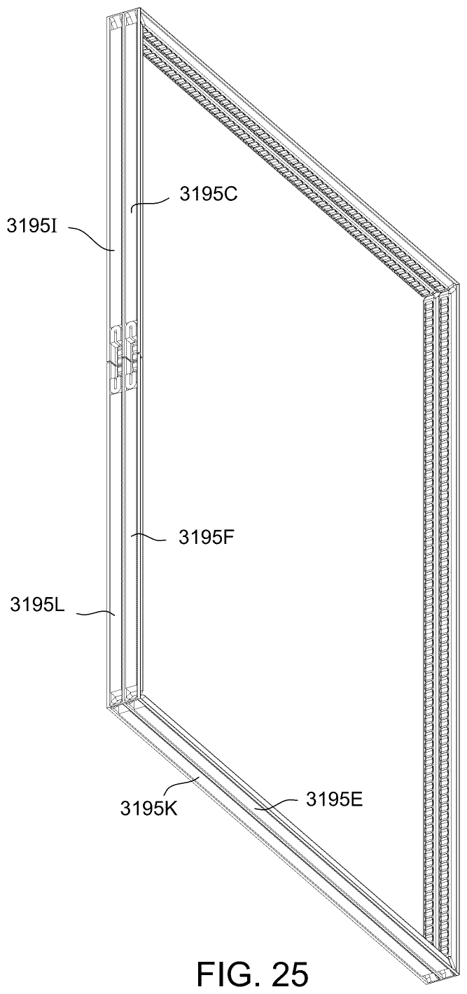

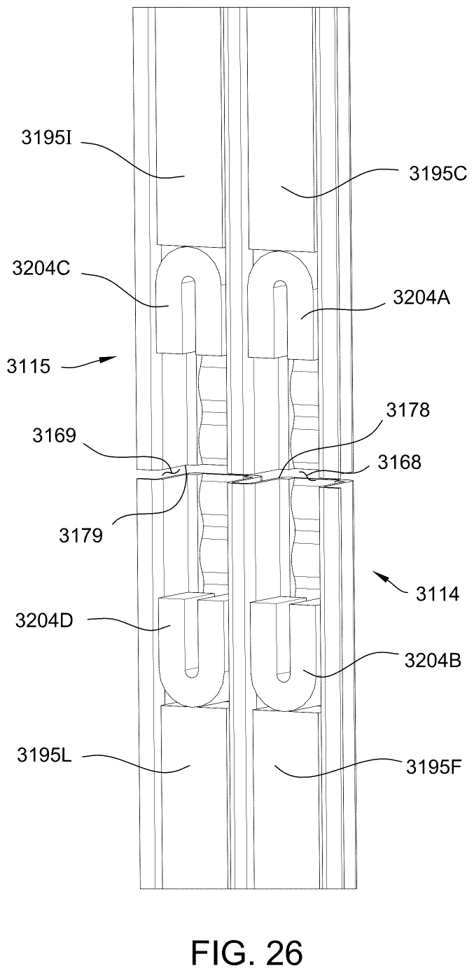

The gas then passes through either a first set of desiccant bodies (e.g., first desiccant body 3195A, second desiccant body 3195B, and third desiccant body 3195C (FIG. 25)) or second set of desiccant bodies (e.g., fourth desiccant body 3195D, fifth desiccant body 3195E (FIG. 25) and sixth desiccant body 3195F). The desiccant bodies of each set may be disposed in all sides of the spacer 3118. The gas then passes through either a fourth filter body 3204A (FIG. 26) or fifth filter body 3204B. The gas then passes through a first gap 3168 formed between the two ends 3178, 3179 of the spacer 3118 into the first gas space 3114.

In the illustrated embodiment, the second gas flow path is identical to the first gas flow path described above. Gas flows through the second port 3104B, and through either a first set of filter, getter and desiccant bodies 3210C, 3207C, 3195G-I, 3204C or a second set of filter, getter and desiccant bodies 3210D, 3207D, 3195J-L, 3204D. The gas then passes through the second gap 3169 and into the second gas space 3115.

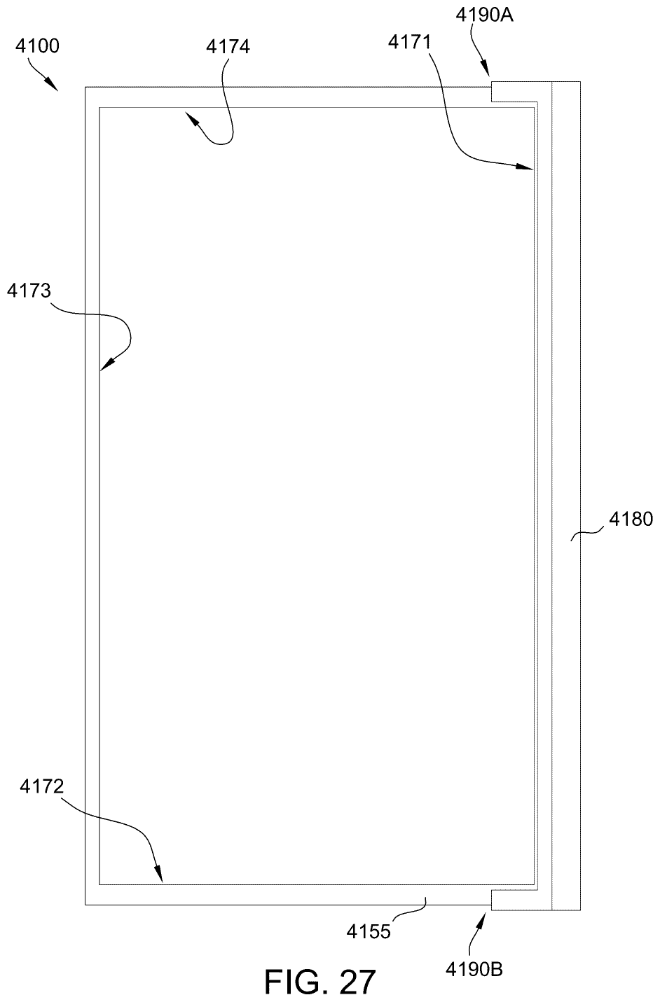

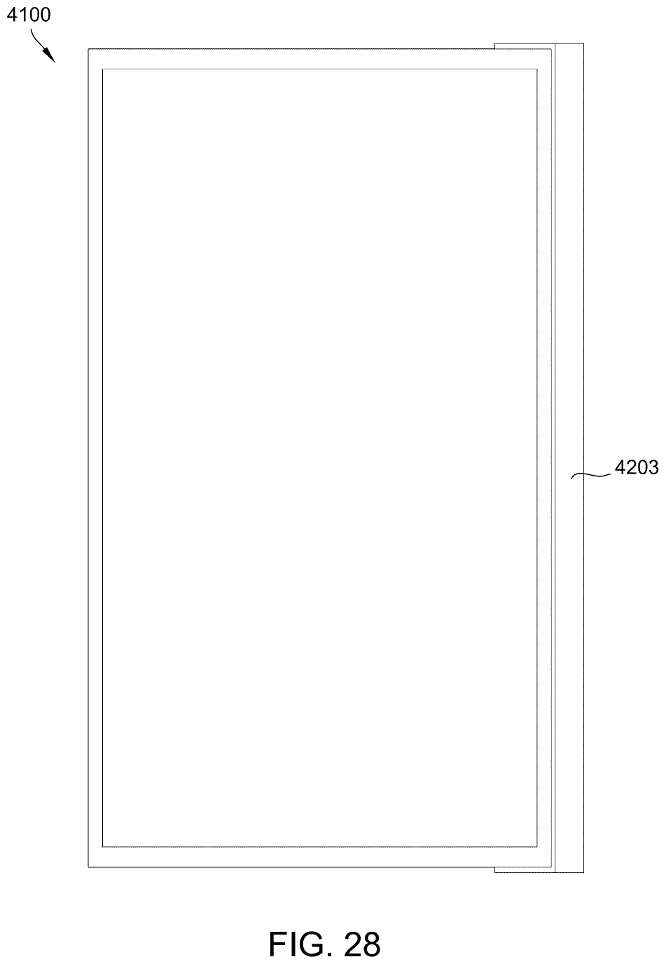

Another embodiment of an insulating glass unit 4100 is shown in FIGS. 27-29. The insulating glass unit 4100 includes an alternative breather 4180. The breather 4180 extends, at least partially, over three sides of the unit 4100 (sides 4171, 4172, 4174 of window panes). The breather 3180 includes two breather inlets 4190A, 4190B through which gas passes during thermal cycles. The moisture vapor barrier film 4155 extends over the sides of the breather 4180 with the breather inlets 4190A, 4190B being open. Disposed within the breather 4180 is a filter body 4203 (FIG. 28) (e.g., particulate filter body made of felt).

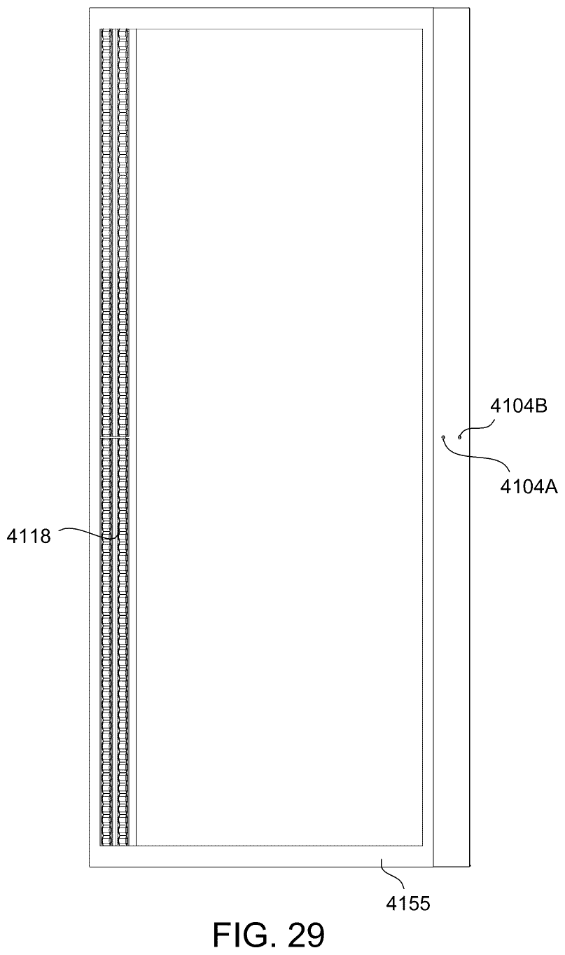

After gas passes through the filter body 4203 it passes through ports 4104A, 4104B (FIG. 29). The insulating glass unit 4100 may include combinations of filters, getter and desiccant bodies as described above for insulating glass unit 3100.

Either breather 3180, 4180 may be used in the other embodiments described above (units 100, 1100, 2100) or with other combinations of filters, getter bodies and desiccants. The breathers 3180, 4180 may allow liquid water to drip from the breathers 3180, 4180 rather than being pulled into the spacer channels. In some embodiments, the breather 3180, 4180 may include an amount of desiccant disposed within the breather (with additional desiccant being disposed within the spacer channels). [Is this ok to state here?]

The spacers 118, 1118, 2118, 3118, 4118 described above may be identical and differ only in the position and number of the preformed corners (and length as with spacer 118 that is used with the corner connector 184). The preformed corners enable the spacers 118, 1118, 2118, 3118, 4118 to conform to the contours of the three window panes.

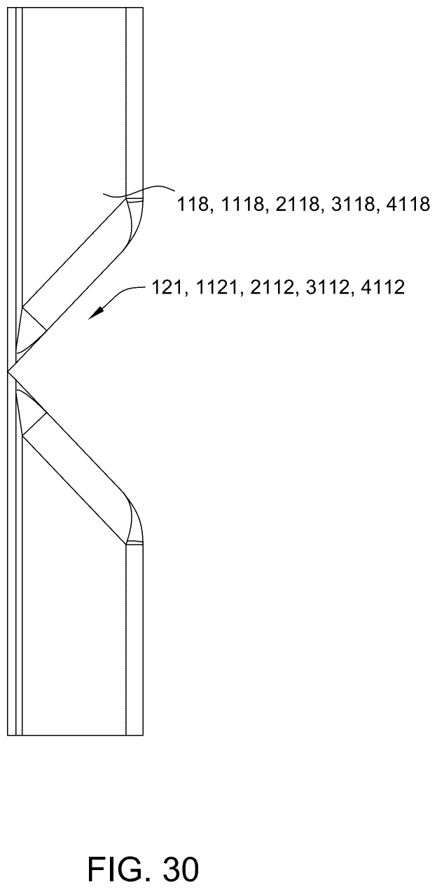

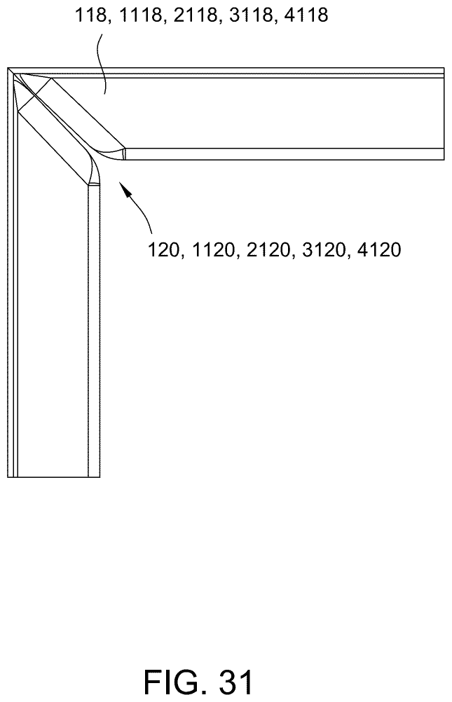

The spacers 118, 1118, 2118, 3118, 4118 may be formed by plastic rolling and corner-crushing techniques (with formation of the spacer 118 being described herein as an example with the description also applying to spacers 1118, 2118, 3118, 4118). The spacer body 119 may be formed by rolling a plastic strip into the shape shown in FIG. 5. Corrugations 158 are then formed on the inner surface 150 of the spacer body 119 such as by passing the spacer body 119 through opposed pairs of toothed wheels which deform the spacer body 199. The spacer back plate 122 is then fixed to the spacer body 119 by welding or by an adhesive. The preformed corners 120 (FIG. 31) are then formed in the spacer. In some embodiments, the preformed corners are made by crushing the spacer 118 at a plurality of corner sites 121 (FIG. 30) (i.e., not notching or bending the spacer to form the preformed corners). Three preformed corners are formed in spacer 118 and four preformed corners are formed in spacers 1118, 2118, 3118, 4118.

To assemble the multi-pane insulating glass unit 100 (and units 1100, 2110, 3110, 4110), the panes 108, 110, 112 may be held by a “rack” or “jig” which holds the panes 108, 110, 112 at the desired spacing. The spacer 118 is placed on one side of the panes 108, 110, 112 and the moisture vapor barrier tape is applied to that side. The spacer 118 is then placed on a successive side of the panes 108, 110, 112 and the tape is applied. This is repeated until the spacer 118 (and the corner connector 184 as in glass unit 100) and tape have been fully applied to the unit 100. To adhere the tape and form the film, pressure may be applied to the tape which seals the tape against the respective surfaces.

In the assembled state, the first window pane 108 is positioned in the first edge rabbet 124, the second window pane 110 is positioned in the second edge rabbet 125, and the third window pane 112 in positioned in the groove 128. Each corner of the plurality of preformed corners of the spacer 118 is positioned at a respective corner of the window panes 108, 110, 112. The moisture vapor barrier film 155 adheres to the outer surface of the first window pane 108, to the spacer back plate 122 (i.e., spacer outer surface 151) and to the outer surface of the second window pane 110. In this manner, the film 155 contacts the outer surfaces of the first and second window panes 108, 110 at the perimeter edge (i.e., without the spacer being disposed between the film and the window pane 108, 112).

Compared to conventional insulating glass units, the insulating glass units of embodiments of the present disclosure have several advantages. Use of a spacer with two chambers formed therein (between panes of glass) allows for various desiccants, filters and getters to be incorporated into the chambers. The first and second chambers may provide for parallel gas pathways or may be connected serially. Use of ports that communicate with the external environment and desiccant bodies allow the insulating glass unit to provide dynamic desiccation (i.e., the equilibrium dewpoint in the gas space is lower than the dewpoint of the environment). The desiccant removes moisture from the air as the gas spaces cool and air enters the unit, thereby keeping the dew point depressed in the gas spaces. When the gas spaces increase in temperature during the day, gas moves from the gas spaces between window panes, through the chambers formed by the spacer and through the port back to the external atmosphere. The outgoing gas dries the desiccant which allows the desiccant to be depleted in moisture for the next thermal cycle. In embodiments in which the desiccant body comprises silica, silica desiccant adsorbs and desorbs moisture in a range that enables the desiccant to properly function in the thermal cycles of an insulating glass unit.

The insulating glass unit is relatively inexpensive to produce (e.g., due to polymer parts and ease in production and assembly) but achieves similar insulating capability compared to other three- or four-pane units (e.g., argon filled, low-emissivity insulating glass units) due to low thermal conductivity of the spacer compared to other units. The life of the unit is greater (e.g., unlimited) while conventional sealed insulating glass units have a finite life. The insulating glass unit keeps its shape because of equivalency in pressure in the gas spaces and the external environment.

In embodiments that include use of a particulate filter body (e.g., felt), particles are removed before downstream gas processing. In embodiments having a gas filter body (e.g., activated carbon), organics may be removed from the air. In embodiments having a getter body, hydrogen sulfide may be removed from the gas. Hydrogen sulfide may react with low-emissivity coating such as silver and decrease window lifetime.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a,” “an,” “the,” and “said” are intended to mean that there are one or more of the elements. The terms “comprising,” “including,” “containing,” and “having” are intended to be inclusive and mean that there may be additional elements other than the listed elements. The use of terms indicating a particular orientation (e.g., “top,” “bottom,” “side,” etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

1-49. (canceled)

50. A spacer for spacing apart a plurality of window panes comprising:
a polymer spacer body comprising:
a first edge rabbet;
a second edge rabbet; and
a groove disposed between the first edge rabbet and the second edge rabbet, the groove being parallel to the first edge rabbet and the second edge rabbet; and
a polymer spacer back plate that is fixed to the spacer body, the spacer body and spacer back plate defining:
a first chamber disposed between the first edge rabbet and the groove; and
a second chamber disposed between the second edge rabbet and the groove.

51. The spacer as set forth in claim 50 wherein the spacer has an inner surface, the first edge rabbet having a first edge rabbet depth that extends from the inner surface to a first edge rabbet floor, the second edge rabbet having a second edge rabbet depth that extends from the inner surface to a second edge rabbet floor, the groove having a groove depth that extends from the inner surface to a groove floor, the groove depth being the same depth as the first edge rabbet depth and the second edge rabbet depth.

52. The spacer as set forth in claim 50 wherein the spacer back plate is fixed to the spacer body by a welding seam or by adhesive.

53. The spacer as set forth in claim 50 wherein the spacer has a plurality of preformed corners to enable the spacer to conform to the contours of the plurality of window panes.

54. The spacer as set forth in claim 50 wherein the spacer body has an inner surface, the inner surface comprising corrugations, each corrugation extending in a direction perpendicular to the groove.

55. A multi-pane insulating glass unit comprising:
a spacer comprising:
a spacer body comprising:
a first edge rabbet;
a second edge rabbet; and
a groove disposed between the first edge rabbet and the second edge rabbet, the groove being parallel to the first edge rabbet and the second edge rabbet;
a spacer back plate that is fixed to the spacer body, the spacer body and spacer back plate defining:
a first chamber disposed between the first edge rabbet and the groove; and
a second chamber disposed between the second edge rabbet and the groove;
a first window pane disposed in the first edge rabbet;
a second window pane disposed in the second edge rabbet; and
a third window pane disposed in the groove.

56. The multi-pane insulating glass unit as set forth in claim 55 comprising:
a moisture vapor barrier film that contacts the first window pane, an outer surface of the spacer and the second window pane; and
a port that extends through the moisture vapor barrier film to form a fluid pathway that extends from an atmosphere external to the multi-pane insulating glass unit to the first chamber or the second chamber.

57. The multi-pane insulating glass unit as set forth in claim 55 wherein the spacer has an inner surface, the first edge rabbet having a first edge rabbet depth that extends from the inner surface to a first edge rabbet floor, the second edge rabbet having a second edge rabbet depth that extends from the inner surface to a second edge rabbet floor, the groove having a groove depth that extends from the inner surface to a groove floor, the groove depth being the same depth as the first edge rabbet depth and the second edge rabbet depth.

58. The multi-pane insulating glass unit as set forth in claim 55 wherein the spacer body has an inner surface, the inner surface comprising corrugations, each corrugation extending in a direction perpendicular to the groove.

59. The multi-pane insulating glass unit as set forth in claim 55 further comprising a desiccant body disposed within at least a portion of the first chamber.

60. The multi-pane insulating glass unit as set forth in claim 55 further comprising a filter disposed within at least a portion of the first chamber.

61. The multi-pane insulating glass unit as set forth in claim 55 further comprising a getter body disposed within at least a portion of the first chamber.

62. A multi-pane insulating glass unit comprising:
a spacer having an outer surface and comprising:
a spacer body comprising:
a first edge rabbet; and
a second edge rabbet;
a spacer back plate that is fixed to the spacer body:
a first window pane disposed in the first edge rabbet;
a second window pane disposed in the second edge rabbet; and
a moisture vapor barrier film that contacts the first window pane, the outer surface of the spacer and the second window pane.

63. The multi-pane insulating glass unit as set forth in claim 62 wherein the spacer body comprises a groove disposed between the first edge rabbet and the second edge rabbet, the groove being parallel to the first edge rabbet and the second edge rabbet, the multi-pane insulating glass unit comprising a third window pane disposed in the groove.

64. The multi-pane insulating glass unit as set forth in claim 62 wherein the first window pane comprises a first window pane outer surface, the first window pane outer surface having perimeter edges, the second window pane comprising a second window pane outer surface, the second window pane outer surface having perimeter edges, the moisture vapor barrier film contacting the first window outer surface at its perimeter edges and contacting the second window outer surface at its perimeter edges.

65. A method for assembling a multi-pane insulating glass unit, the method comprising:
providing a spacer for spacing at least three window panes, the spacer comprising:
a polymer spacer body comprising:
a first edge rabbet;
a second edge rabbet; and
a groove disposed between the first edge rabbet and the second edge rabbet;
a polymer spacer back plate, the spacer body and spacer back plate defining:
a first chamber disposed between the first edge rabbet and the groove; and
a second chamber disposed between the second edge rabbet and the groove;
forming a plurality of corners in the spacer by crushing the spacer at a plurality of corner sites;
positioning a first window pane in the first edge rabbet;
positioning a second window pane in the second edge rabbet;
positioning a third window pane in the groove;
wherein each corner of the plurality of corners is in contact with a corner of the first window pane, a corner of the second window pane and a corner of the third window pane; and
adhering a moisture vapor barrier film to the first window pane, the spacer back plate, and the second window pane such that the first window pane and second window pane are sealed to the spacer.

66. The method as set forth in claim 65 wherein the moisture vapor barrier film is a moisture vapor barrier tape.

67. The method as set forth in claim 65 wherein the first window pane comprises a first window pane outer surface, the first window pane outer surface having perimeter edges, the second window pane comprising a second window pane outer surface, the second window pane outer surface having perimeter edges, the moisture vapor barrier film contacting the first window outer surface at its perimeter edges and contacting the second window outer surface at its perimeter edges.

68. The method as set forth in claim 65 wherein the spacer is not notched or bent to form the plurality of corners.

69. The method as set forth in claim 65 comprising welding the polymer spacer back plate to the polymer spacer body.
